(19) United States
(12) Patent Application Publication
(10) Pub. No.: US 2008/0048370 A1
(43) Pub. Date: Feb. 28, 2008

(54) Bump stop and macpherson strut equipped with such a stop

(75) Inventors: Fabien Corlet, Argonay (FR); Laurent Lebrun-Damiens, Seynod (FR)

Correspondence Address: ARENT FOX LLP, 1050 CONNECTICUT AVENUE, N.W., SUITE 400, WASHINGTON, DC, 20036, US

(73) Assignee: S.N.R. ROULEMENTS

(21) Appl. No.: 11/878,797

(22) Filed: Jul. 26, 2007

(30) Foreign Application Priority Data
Jul. 26, 2006 (FR) 0606853

(51) Int. Cl. F16F 3/08

(52) U.S. Cl. 267/220

(57) ABSTRACT

A Macpherson strut of a vehicle is equipped with a coil spring (10) and a telescopic damper, and a bump stop. The stop comprises a strut bearing (24), an upper support element (18) for transmitting the forces of the telescopic damper and of the bearing to a superstructure of the vehicle, a lower support element (38) made of synthetic material for transmitting to the lower washer the forces exerted by the spring, a cover (22) protecting the bearing and disposed between the upper washer and the upper support element, along with a vibration filtration block (32, 60) of the spring. The bearing is equipped with a lower metal washer (28) rotating in relation to an upper metal washer (26). The cover (22) is disposed between the upper washer and the upper support element and delimits with the lower support element a housing for the bearing. The filtration block is disposed between the upper washer and the cover or built into the cover.

### TECHNICAL FIELD OF THE INVENTION

The invention relates to a bump stop for a vehicle Macpherson strut, in particular for a telescopic Macpherson strut of a motor vehicle steering wheel, equipped with filtration elements for the vibrations transmitted by the spring and by the telescopic damper to the superstructure of the vehicle.

1. Prior Art

In document FR 2 793 732 is described an upper attachment device of a Macpherson strut with a coil spring and a telescopic damper for a motor vehicle steering wheel. Said device comprises an antifriction bearing the lower washer of which forms a spring support and the upper washer forms a cylindrical core on which is supported a dampening pad of the travel limit of the telescopic damper. Between the lower washer and the coil spring is interposed an elastomeric mass which covers, for example by moulding, the inner face of the washer rotated towards the coil. Said elastomeric mass is used to restrain and filter the upper coil of the spring. The elastomeric mass is placed under stress not only in the axial direction but also during shearing, due to the deformations and complex movements of the end of the spring during deflections. In addition, the thickness of the elastomeric mass is not constant because it compensates the offset between the damper rod and the spiral spring, and said variable thickness hinders the filtration. Finally, the elastomeric mass is directly exposed to external contaminations, and is in constant friction against the coil of the spring, which causes rapid wear.

In document U.S. Pat. No. 6,257,605 is described a bump stop consisting of a lower support element, an antifriction bearing and a housing cover for the bearing, equipped with a skirt engaging with the lower support element for defining a labyrinth seal. The stop thus constituted forms a sub-assembly which is mounted between the coil spring and an upper support element constituting the interface with the superstructure of the vehicle. Between the cover and the upper support is interposed an annular dampening block. Said block is not however built into the sub-assembly consisting of the stop, which is not optimal in terms of function integrations.

2. Description of the Invention

The invention therefore aims to resolve the disadvantages of the prior art, so as to propose a bump stop which forms a compact single sub-assembly including the vibration filtration function of the spring in a protect environment.

To this effect, the purpose of the invention is a bump stop device for a Macpherson strut of a vehicle, the strut being equipped with a coil spring and a telescopic damper, the device comprising:
a thrust bearing equipped with a lower metal washer rotating in relation to an upper metal washer;
an upper support element for transmitting the forces of the telescopic damper and of the bearing to a superstructure of the vehicle, the upper support element being equipped with a vibration filtration block of the telescopic damper;
a lower support element made of synthetic material for transmitting to the lower washer the forces exerted by the spring, the lower support element comprising an annular support area of the lower washer and an annular support area of the spring;
a cover disposed between the upper washer and the upper support element, and delimiting with the lower support element a housing for the bearing; and
a vibration filtration block of the spring, disposed between the upper washer and the cover or built into the cover.

The presence of two filtration elements, one dedicated to the vibrations transmitted by the telescopic damper and the other to the spring, allows each filtration element to be individually adapted. The vibration filtration block of the spring may thus be relatively compact, because the vibrations of the spring requiring a filtration are in a relatively high frequency range, above 30 Hz, in particular in the frequency range between 40 and 100 HZ.

The bump stop constitutes a pre-assembled sub-assembly including the filtration function of the spring and filtration of vibrations of the damper.

Due to its positioning above the upper washer, the vibration filtration block of the spring is interposed between the parts which are fixed in rotation in relation to the upper support element and the superstructure of the vehicle. The filtration block is not subjected to any torque and may be optimised for essentially axial stresses. In addition, the block may if necessary also filter the vibrations produced by the bearing itself.

According to one embodiment, the filtration block is disposed between the upper washer and the cover. Said layout allows the filtration block to be further protected from external contaminations. It also facilitates the assembly.

It can also be envisaged that the cover is made of elastomeric material and constitutes the upper support.

Preferentially, the cover is equipped with a skirt covering without touching a peripheral area of the support element and delimiting with the peripheral area of the support element an annular labyrinth, disposed radially outside of the housing and connecting the housing to the outside.

### BRIEF DESCRIPTION OF THE FIGURES

Other advantages and characteristics will emerge more clearly from the description which will follow of the specific embodiments of the invention, given by way of non-limitative example, and shown in the appended drawings on which:

FIG. 1 shows, in axial cross-section, a stop of a Macpherson strut according to a first embodiment of the invention;

FIG. 2 shows, in axial cross-section, a stop of a Macpherson strut according to a second embodiment of the invention.

In order to simplify the presentation, the elements common to the various embodiments will be designated by the same reference signs and their description will not be systematically repeated.

### DETAILED DESCRIPTION OF AN EMBODIMENT

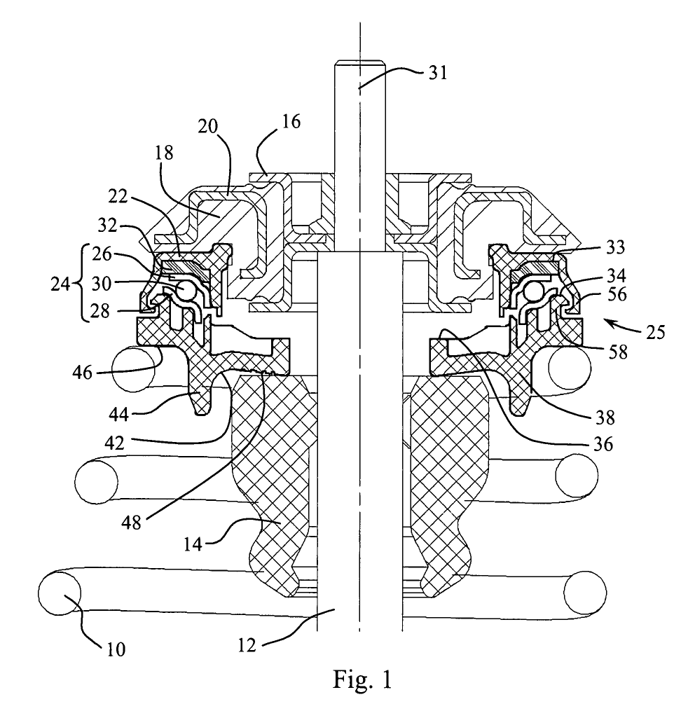

In reference to FIG. 1, a telescopic Macpherson strut comprises a coil spring 10, a telescopic damper of which only the rod 12 is visible, and an impact dampening pad 14, said elements being disposed between one wheel and the body of a vehicle. The rod 12 of the damper is attached at its upper end via a coupling flange 16 to an elastomeric block 18 strengthened by a metal insert 20 and attached, in a known way, to the structure of a vehicle. The elastomeric block 18 also constitutes an upper support seat for a cover 22 wherein is housed an antifriction bearing 24 of a bump stop 25.

The bearing 24 consists of an upper washer 26 and a lower washer 28, both made of pressed steel, and forming rolling paths with oblique contact for rolling bodies such as balls 30 or tapered rollers. The bearing thus defines a rotational axis 31 of the stop. The upper washer 26 is supported by a filtering block made of elastomeric material 32 itself supported by the bottom 33 of the cover 22. The lower washer 28 is supported by a support area 34 constituting a positioning relief at the upper surface 36 of a supporting part 38 made of synthetic material. The supporting part 38 comprises, on the side of its lower surface 42, a cylinder-shaped skirt 44 which separates an outer transversal support shoulder 46 of the spring 10 and an inner transversal support shoulder 48 of the dampening pad 14.

The cover 22 delimits with the supporting part a housing for the bearing 24. The cover 22 is equipped with a skirt 56 covering without touching a peripheral area 58 of the supporting part 38 and delimiting with the peripheral area 58 of the supporting part an annular labyrinth connecting the housing to the outside.

It should be noted that the washers 26, 28 constituting the bearing 22 have a high rigidity, which allows very small clearances to be maintained at the level of the pressure drops. Said washers 26, 28 are preferentially made of 1.2 to 2 mm thick pressed sheet metal. In the example of embodiment, a 1.5 mm sheet metal is used.

The elastomeric material constituting the filtration block is selected in order to allow effective filtering of the specific vibration modes of the spring, in particular in a frequency range located between 40 and 100 Hz. Good results have been obtained with a rubber ring between 2 mm and 10 mm thick, and more specifically between 3 mm and 5 mm.

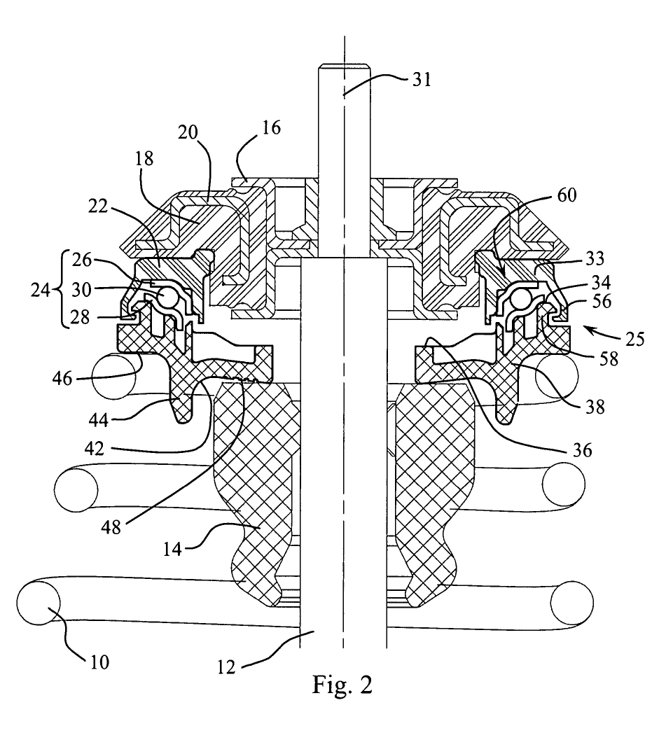

A second embodiment of the invention is shown in FIG. 2. The bump stop of said second embodiment differs from the first embodiment due to the absence of filtering block, 32, the latter being replaced with an overthickness 60 of the cover 22. The cover is, in said embodiment, produced in a relatively rigid elastomeric material, allowing good filtration of the noises transmitted by the spring.

Naturally, various modifications are possible.

The rolling bodies may be rollers. The antifriction bearing may be replaced with a plain bearing.

The lower supporting part may be strengthened with a metal insert. Its lower face may be partially covered with a metal cup.

Between the outer shoulder and the spring may be interposed the annular end of a concertinaed sleeve designed for protecting the damper against external contaminations.

1. A bump stop device for a Macpherson strut of a vehicle, the strut being equipped with a coil spring (10) and a telescopic damper, the device comprising:
a thrust bearing (24) equipped with a lower metal washer (28) rotating in relation to an upper metal washer (26);
an upper support element (18) for transmitting the forces of the telescopic damper and of the bearing to a superstructure of the vehicle, the upper support element being equipped with a vibration filtration block of the telescopic damper;
a lower support element (38) made of synthetic material for transmitting to the lower washer the forces exerted by the spring, the lower support element comprising an annular support area (34) of the lower washer and an annular support area (44) of the spring;
a cover (22) disposed between the upper washer and the upper support element, and delimiting with the lower support element a housing for the bearing; and
a vibration filtration block (32, 60) of the spring, disposed between the upper washer and the cover or built into the cover.

2. A device according to claim 1, further characterised in that the filtration block (32) is disposed between the upper washer and the cover.

3. A device according to claim 1, further characterised in that the cover is made of elastomeric material and constitutes the upper support.

4. A device according to any one of claims 1, 2, or 3, further characterised in that the cover is equipped with a skirt covering without touching a peripheral area (58) of the support element and delimiting with the peripheral area of the support element an annular labyrinth, disposed radially outside of the housing and connecting the housing to the outside.

5. A device according to any one of claims 1, 2, or 3, further characterised in that the filtering block is dimensioned such as to dampen the vibrations in a frequency range extending at least between 40 and 100 Hz.

6. A Macpherson strut of a vehicle comprising a coil spring (10), of a telescopic damper, and a bump stop device according to any one of claims 1, 2, or 3.

7. A Macpherson strut of a vehicle comprising a coil spring (10), of a telescopic damper, and a bump stop device according to claim 4.

8. A Macpherson strut of a vehicle comprising a coil spring (10), of a telescopic damper, and a bump stop device according to claim 5.
